(19) United States
(12) Patent Application Publication
(10) Pub. No.: US 2008/0248821 A1
(43) Pub. Date: Oct. 9, 2008

(54) METHOD FOR SHARING DATA USING SMS

(75) Inventor: Sun-Yong Kim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/140,662

(22) Filed: Jun. 17, 2008

Related U.S. Application Data
(62) Division of application No. 11/332,735, filed on Jan. 13, 2006.

(30) Foreign Application Priority Data
Jan. 27, 2005 (KR) 2005-7600

(51) Int. Cl. H04Q 7/20

(52) U.S. Cl. 455/466

(57) ABSTRACT

Disclosed is a method for sharing data between mobile terminals and between a server and a mobile terminal using SMS. The server provides a search engine necessary to search for data requested by a mobile terminal and share the requested data. The server also has a group list of mobile terminals grouped to share data. A mobile user has to download and install the search engine provided from the server in order to search for desired data in other subscribers' mobile terminals using SMS. The user can effectively search for the desired data using SMS and share the data without any separate communication fee.

### PRIORITY

This application is a Divisional of U.S. application Ser. No. 11/332,735, filed on Jan. 13, 2006, which claims priority to an application entitled “Method for Sharing Data Using SMS” filed with the Korean Intellectual Property Office on Jan. 27, 2005 and assigned Serial No. 2005-7600, the contents of which are incorporated herein by reference.

### BACKGROUND OF THE INVENTION

1. Field of the Invention

The present invention relates to a method for sharing data between mobile terminals, and more particularly to a method for sharing data between mobile terminals using an SMS (Short Message Service).

2. Description of the Related Art

With the development of mobile and wireless technologies, mobile communication terminals such as cell phones and PDAs (Personal Digital Assistants) have been developed to offer various additional functions such as mobile games using images and sounds, an alarm clock and an MP3 player, as well as basic communication functions including an SMS (Short Message Service).

In addition, due to high performance and increased storage capacity, mobile terminals are becoming more integrated to implement even the functions that have been traditionally available only in a desktop or notebook computer. However, to share data such as MP3 music files, bell sounds and images between mobile terminals, users have to use a PC as an intermediate medium for data sharing or to access a network through a base station system. Users can receive only data provided from a service provider by downloading the same through WAP (Wireless Application Protocol) or on the Web, which inconveniences the users and causes time and economic loss. In other words, it is difficult to promptly share desired data between mobile terminals.

SMS is an effective way to provide mobile users with any kind of reminder or information which is typically about 40 characters in length. SMS can be used to send a personal message to an intended recipient or provide useful information such as weather forecasts, news or stock quotes to all subscribing mobile users. A mobile communication system interworks with a short message service center to enable mobile users to send or receive short messages in a text format using the SMS. The short messages can be sent or received between mobile terminals or between an information providing server and a personal mobile terminal. However, the current SMS is a simple one-to-one message transmission service which has a limitation in sending large data amounts of information and which is useful only in sending text-based information.

Conventional SMS merely delivers text-based information, without enabling a mobile user to search for desired data or information in any other user's mobile terminal. It is not a method of searching for content requested by a mobile user in a plurality of mobile terminals or for providing the requested content to the requester's mobile terminal.

To search for and receive large amounts of data such as multimedia content, a mobile user has to access a network and download the data, which incurs a network access fee and an additional fee for the data download.

### SUMMARY OF THE INVENTION

Accordingly, the present invention has been made to solve the above-mentioned problems occurring in the prior art, and an object of the present invention is to provide a method for sharing data between mobile terminals by searching for large amounts of data, such as multimedia content, using SMS and receiving desired data without paying any additional communication fee.

In order to accomplish the above object of the present invention, there is provided a method for sharing data between a plurality of mobile terminals registered with a short message service center, including generating a short message according to a data providing request from a mobile terminal and broadcasting the generated short message to the other registered mobile terminals; detecting whether a response message is sent from any of the other mobile terminals; and receiving requested data from the mobile terminal that has sent the response message using a multimedia messaging service.

In accordance with another aspect of the present invention, there is provided a method for sharing data between a plurality of mobile terminals registered with a server, including generating a short message according to a data providing request from a mobile terminal and sending the generated short message to the server; searching for requested data in a database connected to the server based on the received short message; and when the requested data is detected, receiving the requested data from the server using a multimedia messaging service.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a mobile terminal capable of offering an SMS;

FIG. 2 is a view showing a format of a short message sent from a mobile terminal to request data according to the present invention;

FIG. 3 is a block diagram showing the configuration of a mobile terminal having an SMS-based data sharing function according to the present invention;

FIG. 4 is a flow chart showing a process of sharing data between mobile terminals according to a preferred embodiment of the present invention; and

FIG. 5 is a flow chart showing a process of sharing data between an SMSC and a mobile terminal according to the present invention.

### DETAILED DESCRIPTION OF THE PREFERRED EMBODIMENT

Hereinafter, preferred embodiments of the present invention will be described with reference to the accompanying drawings. In the drawings, the same element, although depicted in different drawings, will be designated by the same reference numeral or character. Also, in the following description of the present invention, a detailed description of known functions and configurations incorporated herein will be omitted when it may make the subject matter of the present invention unclear.

The present invention provides a method for sharing data between mobile terminals and between a server and a mobile terminal using an SMS. The server provides a search engine necessary to search for data requested by a mobile terminal and share the requested data. The server also has a group list of mobile terminals grouped to share data. A mobile user has to download and install the search engine provided from the server in order to search for desired data in other subscribers' mobile terminals using the SMS. The user can effectively search for the desired data using the SMS and share the data without any separate or additional communication fee.

In accordance with a first embodiment of the present invention, there is provided a method for searching for desired data in other subscribers' mobile terminals using a search engine and receiving the desired data. Specifically, when a user inputs a search keyword, his or her mobile terminal (“requester's terminal”) generates a short message including the search keyword and sends the short message to the server via the SMS. Then the server broadcasts the short message including the search keyword to the other mobile terminals registered in the same group list to which the requester's terminal belongs. Upon receiving the short message, each mobile terminal in the same group list searches for data corresponding to the search keyword. When the corresponding data is detected, the search result is forwarded to the server. The server then delivers the result to the requester's terminal. After checking the search result, the requester's terminal sends the server a message informing that it will receive the data detected to correspond to the search keyword. When the mobile terminal that stores the data corresponding to the search keyword receives the message through the server, it sends the corresponding data to the requester's terminal using an MMS (Multimedia Messaging Service). Accordingly, peer-to-peer data sharing can be achieved in a group of mobile terminals.

In accordance with a second embodiment of the present invention, a requester's terminal generates a short message including a search keyword and sends the message to the server. The server determines whether data corresponding to the search keyword is stored in a data-sharing database (DB) connected thereto. When the corresponding data is detected, the server sends the search result to the requester's terminal. After checking the search result, the requester's terminal sends the server a message informing that it will receive the detected data. Then the server provides the requester's terminal with the data corresponding to the search keyword using an MMS. The data-sharing DB stores various data uploaded from the mobile terminals registered with the server. Accordingly, client-to-server data sharing can be achieved between the server and a mobile terminal.

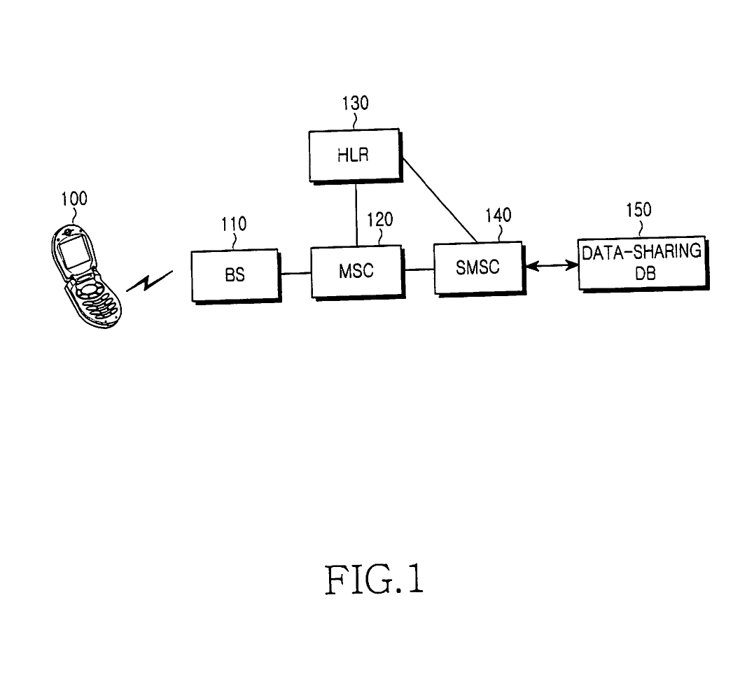

A mobile communication system for providing an SMS generally has a configuration as shown in FIG. 1. Referring to FIG. 1, the mobile communication system includes mobile terminals 100, a base station (BS) 110, a mobile switching center (MSC) 120, a home location register (HLR) 130 and a short message service center (SMSC) 140.

The BS 110 communicates with mobile terminals 100 and controls both the wireless and wire-based links. When a mobile terminal 100 moves to another base station, the BS 110 enables a hand-off procedure to allow the mobile terminal 100 to switch the connection to the other base station and thereby to continue communication. The MSC 120 interworks with other mobile switching centers in a network to process a request for sending/receiving from a mobile terminal 100. The HLR 130 makes inquiries about the users of the mobile terminals 100. As a middle-level computer that manages the mobile users, the HLR 130 stores user information and location information of the mobile terminals 100. The HLR 130 can route calls to each mobile user.

As an independent node, the SMSC 140 is connected to the HLR 130 and the MSC 120 to detect the location of each mobile terminal 100 and delivers a short message to the mobile terminal 100. According to a preferred embodiment of the present invention, the SMSC 140 works as a server that searches data in mobile terminals in a specific group list and enables data sharing between the mobile terminals. The data search is performed only in the mobile terminals that have undertaken user authentication. All the mobile terminals registered with the SMSC 140 can be grouped into a single mobile station group. Alternatively, only specific terminals which have agreed upon grouping can be grouped into a single group. According to another preferred embodiment of the present invention, the SMSC 140, upon receiving a data search request from a mobile terminal, searches a data-sharing DB 150 to detect data corresponding to the search request and sends the detected data to the mobile terminal. The data-sharing DB 150 stores data previously uploaded from the mobile terminals in the same group to share the data.

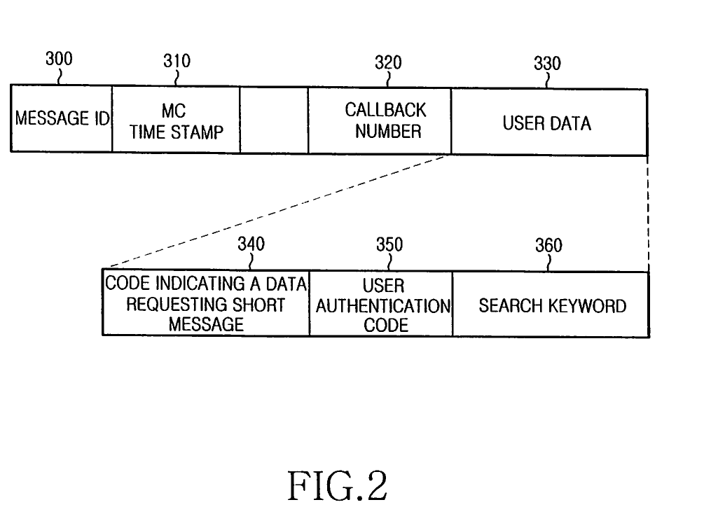

A short message contains fields as shown in FIG. 2 according to a short message sending/receiving protocol. FIG. 2 is a view illustrating the field structure of a short message sent from a mobile terminal to request data according to the present invention.

As illustrated in FIG. 2, each frame of short message data generally includes a message identifier (ID) 300 for identifying a message, a message center (MC) time stamp 310 representing the time when a short message was sent from the SMSC, a callback number 320, user data 330 and other fields necessary to send or receive a short message.

The user data field 330 consists of a code 340 indicating a content requesting short message, an authentication code for the user authentication 350 and a search keyword 360 necessary for the data search. The code field 340 contains a specific code which can be a flag identifying whether the short message is a general message or a request for data search. For example, a flag “1” can be set in the code field 340 of a short message requesting for data search, while “0” can be set in a general short message. Accordingly, mobile terminals that receive a short message can determine whether to process the received short message as a general message or perform a data search by analyzing the flag set in the code field 340 of the received short message.

The authentication code field 350 contains a code assigned to a user subscribing to as a member managed by the SMSC 140. The authentication code can be a password generally required to log in to access a website. Since a password is unique to a single user for user authentication, the use of a password can prevent indiscriminate data-sharing between unsubscribing mobile terminals.

The search keyword field 360 contains a keyword for searching for desired data among multimedia data, huge volume data and other content data. The keyword may include a type of data requested and a registration date of the data.

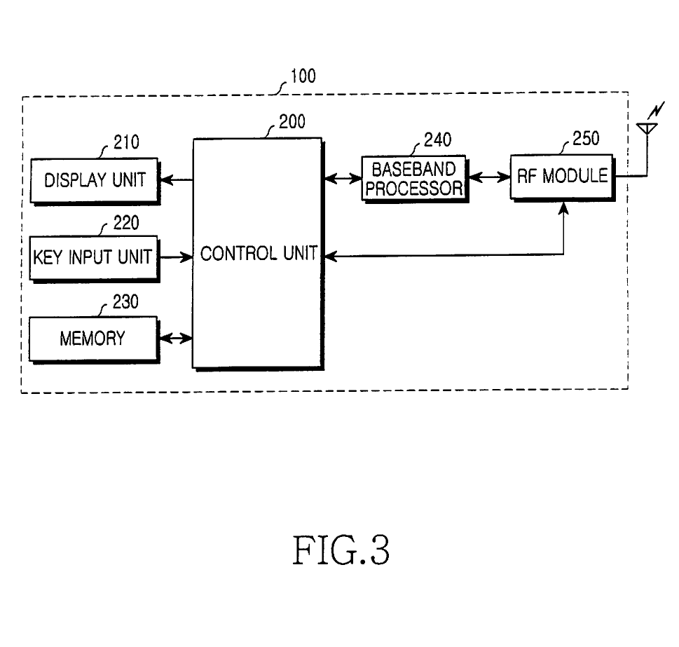

Hereinafter, the operation of a mobile terminal to process a short message having the format explained above will be explained in detail with reference to FIG. 3, which is a block diagram showing the configuration of a mobile terminal having an SMS-based data sharing function according to the present invention.

When a user inputs a search keyword in his or her mobile terminal to search for desired data, a control unit 200 of the mobile terminal generates a short message having a format as illustrated in FIG. 2 based on the input keyword and sends the short message to the SMSC 140. The other mobile terminals that receive the short message via the SMSC 140 determine whether the short message is a general message or a data requesting message. If the received short message is a request for data, the control unit 200 of each of the other mobile terminals performs a data search. To be specific, the control unit 200 of each responder's terminal searches for data corresponding to the search keyword included in the short message. At this time, the control unit 200 searches a shared folder to detect the requested data.

A display unit 210 displays a received short message and various information under the control of the control unit 200. When a user selects a menu to request for data search, the display unit 210 generates a search keyword input window in the form of a popup window. Also, the display unit 210 displays the results of a data search according to an input search keyword.

A key input unit 220 with number keys and various function keys transfers data corresponding to the user's key input to the control unit 200. A memory 230 includes a ROM (Read Only Memory) and a RAM (Random Access Memory) for storing a plurality of programs and information necessary to control the operation of the mobile terminal 100 and a voice memory. The memory 230 stores various types of data such as multimedia data and content. The memory 230 also stores received short messages and a user authentication code to authenticate the user under the control of the control unit 200.

An RF module 250 transmits and receives RF signals to and from the base station 110 through an antenna. The RF module 250 converts a received RF signal into an IF (intermediate frequency) signal and outputs the IF signal to a baseband processor 240. Also, the RF unit 250 converts an IF signal input from the baseband processor 240 into an RF signal and sends the RF signal to the base station 110. As a BAA (Baseband Analog ASIC (Application Specified Integrated Circuit)) that provides an interface between the control unit 200 and the RF module 250, the baseband processor 240 converts a baseband digital signal applied from the control unit 200 into an analog IF signal and applies the analog IF signal to the RF module 250. The baseband processor 240 converts an analog IF signal applied from the RF module 250 into a baseband digital signal and applies the digital signal to the control unit 200.

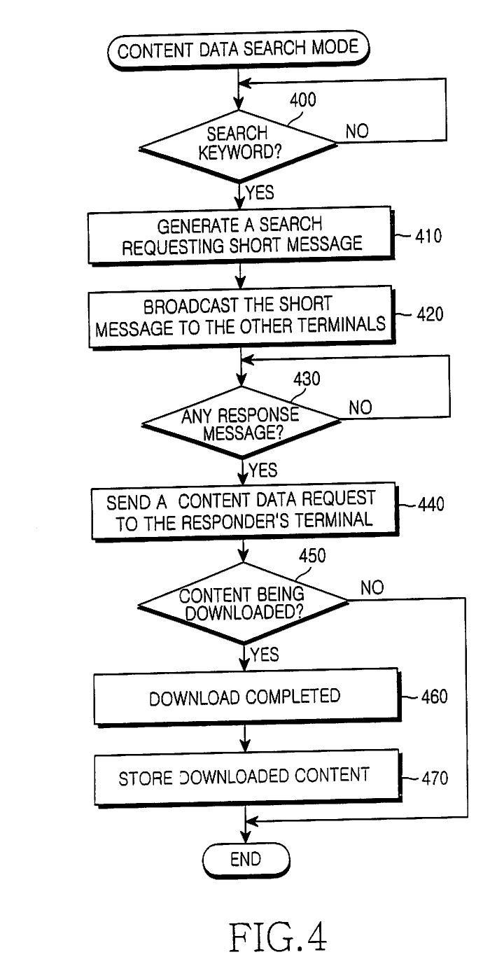

A process of searching for and sharing desired data between mobile terminals using a short message will be explained in detail with reference to FIG. 4, which is a flow chart showing a process of sharing data between mobile terminals according to the present invention. For explanatory convenience, it is assumed that the desired data is content data.

Referring to FIG. 4, the control unit 200 of a data requester's mobile terminal (“requester's terminal”) activates a content search mode that generates a search keyword input window to allow the user to input a keyword of the requested content. At step 400, the control unit 200 determines whether the user has input a keyword in the keyword input window. While the keyword input window is being displayed in the form of a popup window, the user can input any or all search keywords. Also, the user can input the type of the requested data or the registration date of the data in the keyword input window. For example, when the user wishes to search for MP3 music data, he or she may input the complete or partial title of the song or piece of music to be searched for using a search engine. At the same time, the user may also designate MP3 as the type of requested music data. When the user wishes to detect any recently registered data, he or she may input the registration date of the data, for example, “within 3 days” or “within a week.”

Upon input of a search keyword, the control unit 200 proceeds to step 410 to generate a search requesting short message which is in a format as shown in FIG. 2. Subsequently, the control unit 200 sends the generated short message to the SMSC 140 so that the short message can be broadcast to the other subscribers' mobile terminals at step 420. The SMSC 140 broadcasts the search requesting short message to all the terminals registered in a group list. The group list refers to information about mobile terminals allowed to share data.

At step 430, the control unit 200 determines whether a response message has been sent from any of the other subscribers' mobile terminals. The response message indicates whether the content corresponding to the search keyword is detected. Upon receipt of the response message, the control unit 200 requests the responder's terminal that has sent the response message to provide the detected content through the SMSC 140 at step 440. Then the responder's terminal sends the content corresponding to the search keyword to the requester's terminal using an MMS. At step 450, the control unit 200 determines whether the content is being downloaded to the requester's terminal. If it is not, the process ends. If it is, when the content download is completed at step 460, the control unit 200 stores the downloaded content at step 470. As explained above, a mobile user can search for desired data in other mobile terminals in the same data-sharing group using a search engine, thereby obtaining the desired data in an easy and convenient manner.

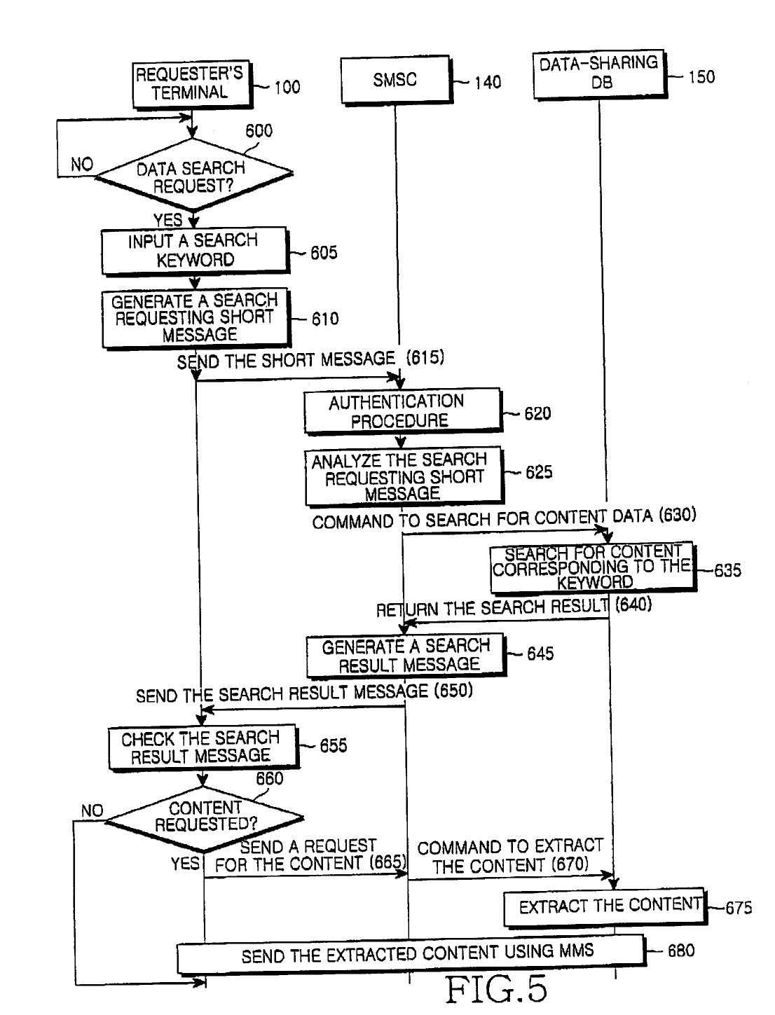

Hereinafter, a process of sharing desired data between the SMSC and a mobile terminal will be explained in detail with reference to FIG. 5, which is a flow chart showing a process of sharing data between the SMSC and a mobile terminal according to the present invention.

Mobile users who wish to use a data search service using a short message should be first registered with the SMSC 140. A user authentication procedure is required to share data between the SMSC 140 and a mobile terminal. In other words, a requester's terminal 100 should install a search engine provided from the SMSC 140 after the authentication procedure. Alternatively, the requester's terminal 100 should first install the search engine provided from the SMSC 140 and then undertake the authentication procedure by sending a search requesting short message with a user authentication code. With the installation of the search engine and the authentication procedure, all the preparations necessary to use the data search service using a short message are completed.

Referring to FIG. 5, at step 600, the requester's terminal 100 determines whether the user has selected a menu for data search request in order to prepare a search requesting short message. When the menu is selected, the requester's terminal 100 proceeds to step 605 so that the user can input a search keyword of the desired data. At step 610, the requester's terminal 100 generates a search requesting short message in the format as shown in FIG. 2. At step 615, the requester's terminal 100 sends the generated short message to the SMSC 140. At step 620, the SMSC 140 analyzes the user authentication code included in the short message and performs the authentication procedure to determine whether the requester's terminal 100 is qualified to share data.

Upon completion of the authentication procedure, the SMSC 140 analyzes the received short message at step 625. In other words, the SMSC 140 determines whether the short message is a general message or a request for data search. If the received message is a search requesting short message, the SMSC 140 extracts the search keyword included in the message to perform a search for corresponding content in the data-sharing DB 150. In this regard, at step 630, the SMSC 140 sends the data-sharing DB 150 a command to search for the corresponding content. At step 635, the data-sharing DB 150 performs a search based on the search keyword according to the command. When the corresponding content is detected, the data-sharing DB 150 sends the search result to the SMSC 140 at step 640.

At step 645, the SMSC 140 generates a search result message based on the search result received from the data-sharing DB 150. At step 650, the SMSC 140 sends the search result message to the requester's terminal 100. At step 655, the requester's terminal 100 checks the search result message received from the SMSC 140. In view of the search result message, the user can confirm whether the desired content was detected. In the affirmative, the user may send the SMSC 140 a request message for receiving the detected content.

At step 660, the requester's terminal 100 determines whether the user has input a request for receiving the detected content. At step 665, the requester's terminal 100 sends the input request to the SMSC 140. In response to the request, the SMSC 140 sends a command at step 670 to extract the requested content to the data-sharing DB 150, so that the data-sharing DB 150 will extract the content at step 675. Then the SMSC 140 proceeds to step 680 to deliver the extracted content data to the requester's terminal 100 using an MMS. In accordance with the present invention, the MMS is used to transmit the detected content to the requester's terminal 100. MMS enables the terminal to receive huge volume multimedia data as well as simple information to be shared. The data-sharing DB 150 stores various data uploaded from the previously registered mobile terminals. When the process of providing the detected data to the requester's terminal 100 is completed, the SMSC 140 may also send a short message to the responder's terminal to inform the terminal of the data sharing result.

According to the present invention, a mobile user can effectively search for desired data in other mobile terminals via an SMS. This search function can be implemented using an existing message sending protocol, thereby reducing the communication cost.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for sharing data between a plurality of mobile terminals registered with a server, comprising the steps of:
generating a short message according to a request for data from a mobile terminal and sending the generated short message to the server;
searching for requested data in a database connected to the server based on the received short message; and
when the requested data is detected, receiving the requested data from the server using a multimedia messaging service.

2. The method as claimed in claim 1, wherein said searching step includes:
extracting a search condition from a format of the short message; and
searching a database connected to the server to detect data corresponding to the extracted search condition.

3. The method as claimed in claim 2, wherein said database stores data previously uploaded from the plurality of mobile terminals registered with the server.
